(19) United States
(12) Patent Application Publication
(10) Pub. No.: US 2008/0288537 A1
(43) Pub. Date: Nov. 20, 2008

(54) SYSTEM AND METHOD FOR SLIDE STREAM INDEXING BASED ON MULTI-DIMENSIONAL CONTENT SIMILARITY

(75) Inventors: Gene Golovchinsky, Menlo Park, CA (US); Jeremy Pickens, Milpitas (CA); Laurent Denoue, Palo Alto, CA (US)

Correspondence Address: FLIESLER MEYER LLP, 650 CALIFORNIA STREET, 14TH FLOOR, SAN FRANCISCO, CA, 94108, US

(73) Assignee: FUJI XEROX CO., LTD., Tokyo (JP)

(21) Appl. No.: 11/749,398

(22) Filed: May 16, 2007

(51) Int. Cl. G06F 17/30

(52) U.S. Cl. 707/104.1; 707/E17.122

(57) ABSTRACT

Embodiments of the present invention enable an approach to index segments of a media stream containing of visual and textual information, using a combination of visual, textual, auditory and temporal features to combine segments that correspond to topical contexts into logical groups. A visual/temporal/auditory/textual weighting scheme is adopted, which allows segments from elsewhere in the same media stream to affect the index terms associated with the current segment. This description is not intended to be a complete description of, or limit the scope of, the invention. Other features, aspects, and objects of the invention can be obtained from a review of the specification, the figures, and the claims.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

This invention relates to the field of stream media indexing based on similarities.

2. Description of the Related Art

Streams of media such as slides of a captured presentation need to be segmented for indexing and subsequent full-text retrieval purposes. Traditionally, this indexing has been performed based on visual similarity. Once segmented, text was extracted from each slide via Optical character recognition (OCR) and a full-text index entry (document) was built for each slide. While this approach worked reasonably well, it was limited in at least two ways. First, OCR introduced recognition errors, decreasing the performance of subsequent full-text queries, and the relatively small amount of text per slide made it harder to identify term co-occurrence which underpins effective query performance; Second, segmented data streams are hard to index when the textual information associated with each segment is limited and noisy. Accurate textual information is important for ad-hoc retrieval of segments from data streams.

### SUMMARY OF THE INVENTION

Various embodiments of the present invention enable an approach to index segments of a media stream containing visual and textual information, using a combination of visual, textual, auditory and temporal features to group segments that correspond to topical contexts into logical groups. A visual/temporal/auditory/textual weighting scheme is adopted, which allows segments from elsewhere in the same presentation to affect the index terms associated with the current segment.

### BRIEF DESCRIPTION OF THE DRAWINGS

Preferred embodiment(s) of the present invention will be described in detail based on the following figures, wherein:

FIG. 1 is an illustration of an exemplary system for similarity-based indexing of media stream in one embodiment of the present invention;

FIG. 2 is a flow chart illustrating an exemplary flow chart for similarity-based indexing of media stream in one embodiment of the present invention.

### DETAILED DESCRIPTION OF THE INVENTION

The invention is illustrated by way of example and not by way of limitation in the figures of the accompanying drawings in which like references indicate similar elements. It should be noted that references to “an” or “one” or “some” embodiment(s) in this disclosure are not necessarily to the same embodiment, and such references mean at least one.

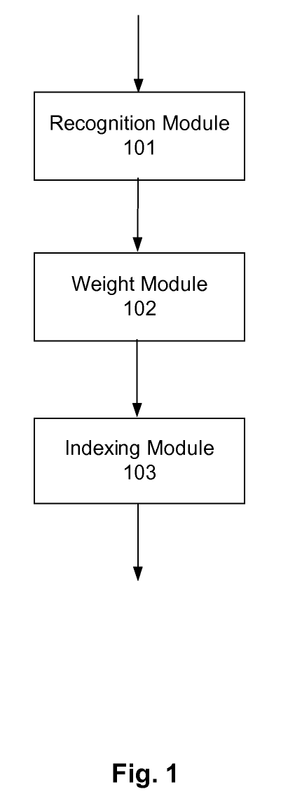

FIG. 1 is an illustration of an exemplary system for similarity-based indexing of media stream in one embodiment of the present invention. Although this diagram depicts components as functionally separate, such depiction is merely for illustrative purposes. It will be apparent to those skilled in the art that the components portrayed in this figure can be arbitrarily combined or divided into separate software, firmware and/or hardware components. Furthermore, it will also be apparent to those skilled in the art that such components, regardless of how they are combined or divided, can execute on the same computing device or multiple computing devices, and wherein the multiple computing devices can be connected by one or more networks.

Referring to FIG. 1, a recognition module 101 is operable to extract plural terms from plural segments of an incoming media stream. Here, the media stream can be but is not limited to slides in a captured power point presentation. For each segment, a weight module 102 is operable to compute a weight vector based on the visual, textual, temporal, and audio similarities between the current segment and its neighboring segments. Neighboring segments to the current segment are not limited to temporally contiguous segments. Any segment in the media stream is theoretically a neighbor to the current segment. An indexer 103 can then build an index (kernel or a weighted profile) of the current segment by including both the terms of the current segment and the weight-adjusted terms of its neighboring segments.

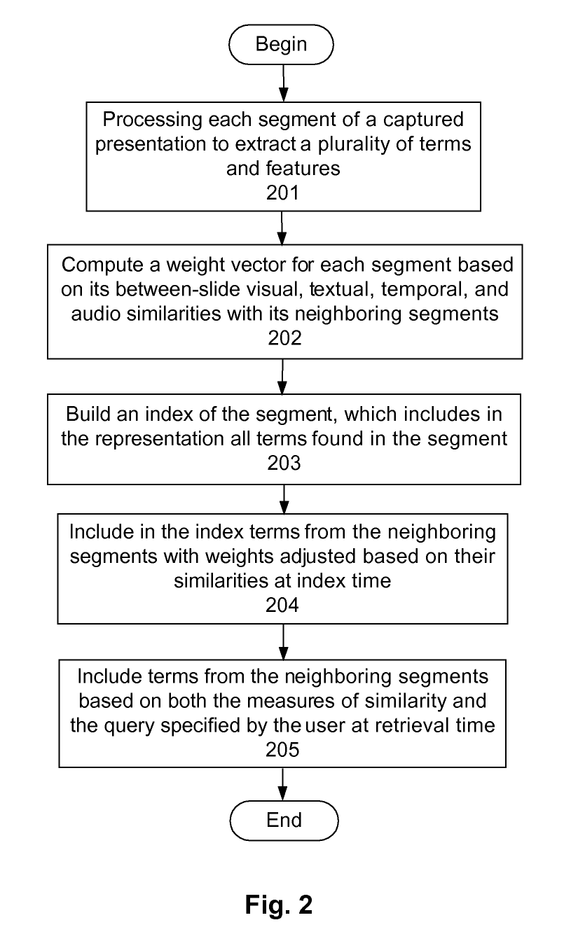

FIG. 2 is a flow chart illustrating an exemplary flow chart for similarity-based indexing of a media stream in one embodiment of the present invention. Although this figure depicts functional steps in a particular order for purposes of illustration, the process is not limited to any particular order or arrangement of steps. One skilled in the art will appreciate that the various steps portrayed in this figure could be omitted, rearranged, combined and/or adapted in various ways.

Referring to FIG. 2, each segment of a captured presentation is processed to extract plural terms and features at step 201. For each segment, a weight vector is computed at step 202 based on its between-segment visual, textual, temporal, and audio similarities with its neighboring segments. An index of the segment can then be built, which includes in the representation of that segment all terms found in the segment at step 203. At index time, the index will also include terms from the neighboring segments with weights adjusted based on their similarities at step 204. At retrieval time, terms from the neighboring segments can be included based on both the measures of similarity and the query specified by the user at step 205.

In some embodiments, the similarities between the indexed segment and its neighboring segments include but are not limited to, the overlap, which can be but is not limited to syntactic, semantic, linguistic or statistical similarity, among terms found on the neighboring segments, their temporal and sequential proximity, and similarity between visual features of the segments. This expanded and re-weighted term vector would be used to index each segment, thereby allowing the retrieval of concepts that are distributed among neighboring segments, and improving term frequency-based metrics by smoothing them over multiple segments.

In some embodiments, textual terms in a segment can be generated for assessing textual similarity with its neighbors in a number of ways. One standard text segmentation technique is to run a fixed-length window over the text, computing measures of coherence, which can be but are not limited to, statistical, symbolic, probabilistic and the like, over the window, and thresholding the resulting value to generate coherent passages. Alternatively, lexical units such as paragraphs or sentences can be used to generate passages. Finally, text may be segmented into fixed-word-count passages. While traditionally used for splitting a document into multiple pieces, these techniques can be used in reverse, to join text associated with neighboring segments into a single weight vector.

In some embodiments, weight vector can be computed based on a distance within some feature space, which can be but is not limited to, Euclidian and statistical, with features derived from one or more of the following factors:
1. The degree of similarity of segment-specific terms. The closer the vocabulary of two segments, the more likely terms from neighboring segments are to be used to retrieve the target. The exact function can be determined empirically.
2. The time separating the two segments. Segments presented relatively closely together may be more likely to be related. It is possible to train a machine learning algorithm to estimate relatedness between adjacent segments based on the amount of time each is displayed. This score could be used to modulate the degree of similarity computed above.
3. The sequence of segments. Except in cases where other factors (such as textual or visual similarity) are involved, adjacent segments are more likely to be grouped meaningfully, so discounting textual similarity as the inter-segment distance increases should be factored into the term weights.
4. Visual similarity features. Features that include but are not limited to, common headings or footers, common visual elements such as icons or images, common colors and/or color schemes, and patterns of text hierarchies in bulleted lists, are all examples of visual features based on which inter-segment similarity can be measured. Similarity scores computed between segments can be used to modulate term frequency information from neighboring segments.
5. Use of audio/timbral/prosodic similarity of the recorded voices of the speakers. In other words, if audio that corresponds to a segment has been recorded, acoustic features derived from the audio can be used to assess similarity.
   Other schemes for determining term weights are also possible. For a non-limiting example, a Bayesian statistically-based similarity metric that accommodates multiple feature dimensions can be adopted. Alternatively, a maximum-entropy approach can be used to combine the features described above.

In some embodiments, the term weight vector can be incorporated into an index once it is computed. Two exemplary strategies for incorporating the term weight vector are: index-time and query-time grouping.

Index-time grouping involves creating coherent documents based on groups of adjacent segments of sufficient similarity. Two or more adjacent segments can be grouped together into a single document, indexed with all their contained terms, and retrieved as a unit.

In query-time grouping, segments are indexed individually, and then grouped after query evaluation to produce a query-biased grouping in which the weights of query terms or other related terms are boosted in computing the grouping.

In some embodiments, the segment group approach can compensate for OCR errors by increasing the likelihood that a correctly-recognized term will be associated with a group of segments. As a non-limiting example, assume a term (feature) occurs in three consecutive segments and it is mis-recognized in two of three cases. Without segment grouping, only the segment that contains the correctly-recognized word would be retrieved. With segment grouping, the correctly spelled variant would be propagated to its neighboring segments, increasing the likelihood of retrieval.

One embodiment may be implemented using a conventional general purpose or a specialized digital computer or microprocessor(s) programmed according to the teachings of the present disclosure, as will be apparent to those skilled in the computer art. Appropriate software coding can readily be prepared by skilled programmers based on the teachings of the present disclosure, as will be apparent to those skilled in the software art. The invention may also be implemented by the preparation of integrated circuits or by interconnecting an appropriate network of conventional component circuits, as will be readily apparent to those skilled in the art.

One embodiment includes a computer program product which is a machine readable medium (media) having instructions stored thereon/in which can be used to program one or more computing devices to perform any of the features presented herein. The machine readable medium can include, but is not limited to, one or more types of disks including floppy disks, optical discs, DVD, CD-ROMs, micro drive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data. Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, execution environments/containers, and applications.

The foregoing description of the preferred embodiments of the present invention has been provided for the purposes of illustration and description. It is not intended to be exhaustive or to limit the invention to the precise forms disclosed. Many modifications and variations will be apparent to the practitioner skilled in the art. Particularly, while the concept “module” is used in the embodiments of the systems and methods described above, it will

3 be evident that such concept can be interchangeably used with equivalent concepts such as, bean, class, method, type, component, interface, object model, and other suitable concepts. Embodiments were chosen and described in order to best describe the principles of the invention and its practical application, thereby enabling others skilled in the art to understand the invention, the various embodiments and with various modifications that are suited to the particular use contemplated. It is intended that the scope of the invention be defined by the following claims and their equivalents.

What is claimed is:

1. A system to support similarity-based media stream indexing, comprising:
a recognition module operable to extract a plurality of terms from a plurality of segments of a media stream;
a weight module operable to compute a weight vector for at least one of the segments based on similarities between the segment and its neighboring segments in the media stream; and
an indexer operable to create an index of the segment, wherein the index incorporates at least the following:
the plurality of terms found on the segment; and
the plurality of terms from its neighboring segments with weights adjusted by the weight vector.

2. The system according to claim 1, wherein:
the similarities between the segment and its neighboring segments include one or more of visual, textual, temporal, and audio similarities.

3. The system according to claim 2, wherein:
the recognition module is operable to generate text terms of the segment for assessing textual similarity via at least one of:
computing measure of coherence over a fixed-length window over text of the segment and thresholding the resulting value;
utilizing lexical units, which are paragraphs or sentences; and
segmenting text of the segment into fixed-word-count passages.

4. The system according to claim 3, wherein:
type of the measure of coherence is one of: symbolic and probabilistic.

5. The system according to claim 1, wherein:
the similarities between the segment and its neighboring segments include one or more of: overlap among the plurality of terms found on the segments, temporal and sequential proximity of the segments, and similarity between visual and/or acoustic features of the segments.

6. The system according to claim 1, wherein:
the weight vector is based on a term distance within Euclidian and/or statistical space.

7. The system according to claim 1, wherein:
the weight module is operable to compute the weight vector based on at least one of:
degree of similarity of segment-specific terms on the segments;
time separating the segments;
sequence of the segments;
visual features of the segments; and
audio, timbral, and prosodic similarity of the segments.

8. The system according to claim 7, wherein:
the visual features are one or more of: common headings or footers, common visual elements, common colors and/or color schemes, and patterns of text hierarchies in bulleted lists.

9. The system according to claim 1, wherein:
the indexer is further operable to incorporate in the index the plurality of terms from the neighboring segments with weights adjusted by both the weight vector and the query specified by a user at retrieval time.

10. The system according to claim 1, wherein:
the indexer is further operable to incorporate the weight vector via index-time grouping and/or query-time grouping.

11. A method to support similarity-based media stream indexing, comprising:
extracting a plurality of terms from a plurality of segments of a media stream;
computing a weight vector for one of the segments based on similarities between the segment and its neighboring segments in the media stream;
creating an index of the segment, wherein the index incorporates at least the following:
the plurality of terms found on the segment; and
the plurality of terms from its neighboring segments with weights adjusted by the weight vector.

12. The method according to claim 11, further comprising:
generating text terms of the segment for assessing textual similarity via at least one of:
computing statistical or linguistic measures of coherence over a fixed-length window over text of the segment and thresholding the resulting value;
utilizing lexical units, which are paragraphs or sentences; and
segmenting the text of the segment into fixed-word-count passages.

13. The method according to claim 11, further comprising:
computing the weight vector based on at least one of:
degree of similarity of segment-specific terms on the segments;
time separating the segments;
sequence of the segments;
visual features of the segments; and
audio, timbral, and prosodic similarity of the segments.

14. The method according to claim 11, further comprising:
incorporating in the index the plurality of terms from the adjacent segments with weights adjusted by both the weight vector and the query specified by a user at retrieval time.

15. The method according to claim 11, further comprising:
incorporating the weight vector via index-time grouping and/or query-time grouping.

16. A machine readable medium having instructions stored thereon that when executed cause a system to:
extract a plurality of terms from a plurality of segments of a media stream;
compute a weight vector for one of the segments based on similarities between the segment and its neighboring segments in the media stream;
create an index of the segment, wherein the index includes at least the following:
the plurality of terms found on the segment; and
the plurality of terms from its neighboring segments with weights adjusted by the weight vector.

17. A system to support similarity-based media stream indexing, comprising:
means for extracting a plurality of terms from each of a plurality of segments of a media stream;
means for computing a weight vector for one of the segments based on similarities between the segment and its neighboring segments in the presentation;
means for creating an index of the segment, wherein the index includes at least the following:
the plurality of terms found on the segment; and
the plurality of terms from its neighboring segments with weights adjusted by the weight vector.
